(19) United States
(12) Patent Application Publication
(10) Pub. No.: US 2024/0171014 A1
(43) Pub. Date: May 23, 2024

(54) ON-DEMAND SATELLITE POWER DISTRIBUTION

(71) Applicant: International Business Machines Corporation, Armonk, NY (US)

(72) Inventors: Sarbajit K. Rakshit, Kolkata (IN); Naeem Altaf, Round Rock, TX (US)

(21) Appl. No.: 17/989,154

(22) Filed: Nov. 17, 2022

(51) Int. Cl. H02J 50/30; H02J 50/80

(52) U.S. Cl. CPC H02J 50/30; H02J 50/80

(57) ABSTRACT

Providing power to orbiting satellites by providing an array including at least one power supply satellites, receiving a power request from a customer satellite, ensuring angular alignment between a power transmitting element of a supply satellite and a power receiving element of the customer satellite, transmitting power from the supply satellite to the customer satellite, and recording the quantity of power transmitted from the supply satellite to the customer satellite.

### FIELD OF THE INVENTION

The disclosure relates generally to the distribution of power to orbiting satellites. The invention relates particularly to the on-demand distribution of power to orbiting satellites.

### BACKGROUND

Optical Power Beaming includes a process for converting electricity into laser light, sending the laser light some distance away and then converting the laser light back into usable electricity. Shaping and conditioning optimize the beam of laser light for power, distance and efficiency. Power supply systems may be packaged and controlled to be safe. For wireless power beaming, a beam may be sent through the air and “caught” using specialized solar panels. Wireless power beaming can reliably send power over hundreds of feet, and even miles, to stationary or moving equipment and vehicles, on the ground or even in the air.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable distribution of power among orbiting satellites.

Aspects of the invention disclose methods, systems and computer readable media associated with providing power to orbiting satellites by providing an array including at least one power supply satellites, receiving a power request from a customer satellite, ensuring angular alignment between a power transmitting element of a supply satellite and a power receiving element of the customer satellite, transmitting power from the supply satellite to the customer satellite, and recording the quantity of power transmitted from the supply satellite to the customer satellite.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a system according to an embodiment of the invention.

FIG. 2 provides a schematic illustration of a computing environment, according to an embodiment of the invention.

FIG. 3 provides a flowchart depicting an operational sequence, according to an embodiment of the invention.

FIG. 4 depicts a cloud computing environment, according to an embodiment of the invention.

FIG. 5 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

In-Space Manufacturing (ISM) involves a comprehensive set of processes aimed at the production of manufactured goods in the space environment. ISM is also often used interchangeably with the term in-orbit manufacturing given that current production capabilities are limited to low Earth orbit. There are several rationales supporting in-space manufacturing: The space environment, in particular the effects of microgravity and vacuum, enable the research of and production of goods that could otherwise not be manufactured on Earth. The extraction and processing of raw materials from other astronomical bodies, also called In-Situ Resource Utilization (ISRU) could enable more sustainable space exploration missions at reduced cost compared to launching all required resources from Earth. Raw materials could be transported to low Earth orbit where they could be processed into goods that are shipped to Earth. By replacing terrestrial production on Earth, this is seeking to preserve the Earth. Raw materials of very high value, for example gold, silver, or platinum, could be transported to low Earth orbit for processing or transfer to Earth which is thought to have the potential to become economically viable.

ISM offers several unique differences between the properties of materials in space compared to the same materials on the Earth. These differences can be exploited to produce unique or improved manufacturing techniques. A microgravity environment allows control of convection in liquids or gasses, and the elimination of sedimentation. Diffusion becomes the primary means of material mixing, allowing otherwise immiscible materials to be intermixed. The environment allows enhanced growth of larger, higher-quality crystals in solution. The ultraclean vacuum of space enables the creation of very pure materials and objects. The use of vapor deposition can be used to build up materials layer by layer, free from defects. Surface tension causes liquids in microgravity to form perfectly round spheres. This can cause problems when trying to pump liquids through a conduit, but it is very useful when perfect spheres of consistent size are needed for an application. ISM provides access readily available extremes of temperature. Sunlight can be focused to concentrate enough heat to melt materials, while objects kept in shade are exposed to temperatures close to absolute zero. The temperature gradient between illuminated and shaded areas can be exploited to produce strong, glassy materials.

In-space manufacturing units performing manufacturing activities while orbiting around earth, will require differing amounts of power depending upon the volume of manufacturing performed, the types of activities etc. The required amount of power may exceed the power stored in the battery of an in-space manufacturing satellite, peak power requirements may exceed the power generating capacity and stored power of an individual ISM unit, an ISM satellite may have problem with power generation or a power storage battery, rendering the ISM satellite unable to meet its internal power needs. Providing sufficient solar panel power generation capacity for individual satellites requires complex and expensive solar panel arrays for individual satellites. Disclosed systems and methods provide for the generation and distribution of power across a network of satellites including customer ISM satellites and power generation satellites, without the need for individual customer satellite solar panel or other power generation systems.

Aspects of the present invention relate generally to the utilization of power beaming technology to distribute power from an array of power generation satellites to a network of one or more customer satellites. The distribution may be automatically controlled by a computer controlled power distribution application. A customer satellite may request power from the generation/distribution array. In turn, the array ensures alignment of array power transmission elements with customer power receiving elements and proceeds to beam the requested power from the distribution array to the customer satellite. In an embodiment, as the generation/distribution array may comprise satellites associated with different commercial power suppliers, the computer application tracks customer requests and associated supplier fulfillment actions using a ledger.

A decentralized database is a distributed storage system which includes multiple nodes that communicate with each other. A blockchain is an example of a decentralized database which includes an append-only immutable data structure resembling a distributed ledger capable of maintaining records between mutually untrusted parties. The untrusted parties are referred to herein as peers or peer nodes. In an embodiment, power distribution customers and power providers constitute peers for the data storage ledger.

Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In a public, or permission-less blockchain, anyone can participate without a specific identity. Public blockchains often involve native crypto-currency and use consensus based on various protocols such as Proof of Work (PoW). On the other hand, a permissioned blockchain database provides a system which can secure inter-actions among a group of entities which share a common goal, but which do not fully trust one another, such as businesses that exchange funds, goods, information, and the like.

A blockchain operates arbitrary, programmable logic, tailored to a decentralized storage scheme and referred to as “smart contracts” or “chaincodes.” In some cases, specialized chaincodes may exist for management functions and parameters which are referred to as system chaincode. Smart contracts are trusted distributed applications which leverage tamper-proof properties of the blockchain database and an underlying agreement between nodes which is referred to as an endorsement or endorsement policy. In general, blockchain transactions typically must be “endorsed” before being committed to the blockchain while transactions which are not endorsed are disregarded. A typical endorsement policy allows chaincode to specify endorsers for a transaction in the form of a set of peer nodes that are necessary for endorsement. When a client sends the transaction to the peers specified in the endorsement policy, the policy is executed to validate the transaction. After validation, the transactions enter an ordering phase in which a consensus protocol is used to produce an ordered sequence of endorsed transactions grouped into blocks.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a customer/client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

A ledger is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). A transaction may result in a set of asset key-value pairs being committed to the ledger as one or more operands, such as creates, updates, deletes, and the like. The ledger includes a blockchain (also referred to as a chain), which is used to store an immutable, sequenced record in blocks. The ledger also includes a state database which maintains a current state of the blockchain. There is typically one ledger per channel. Each peer node maintains a copy of the ledger for each channel of which they are a member.

A chain is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

One of the benefits of the example embodiments is that it improves the functionality of a computing system by implementing a method for providing a selective access to asset transfer data on blockchain-based systems. Through the blockchain system described herein, a computing system can perform functionality for determination that the asset recipient is the registered user of a relevant blockchain, for encoding the asset transfer transactions by a public key associated with a private key of an auditor of a blockchain, and for providing the encoded asset transfer transaction memorializing the requests for power and the actual transfers of power from the power generation/distribution array. Also, the blockchains enable the creation of a business network and make enable users or organizations to on-board for participation. As such, the blockchain is not just a database. The blockchain comes with capabilities to create a Business Network of users and on-board/off-board organizations to collaborate and execute service processes in the form of smart contracts.

In an embodiment, a blockchain ledger enables the transfers for power. In this embodiment, a request from a customer initiates a new ledger entry including the satellite details—orbital location and dynamics details, customer account information, current power requirements in terms of power needed and the estimated time span for the need. The request further includes a digital signature associated with the customer. In an embodiment, peers within the customer and supplier network utilizing the blockchain validate the power request using the provided digital signature of the customer as a valid network digital signature. After submission and validation of the power transfer request, the computer control system identifies power generation/distribution satellites capable of providing power to the customer satellite according to the provided location and orbital dynamics information. In an embodiment, the system selects a power generation satellite to provide the requested power. The system may select the provider satellite according to the proximity of the satellite to the requesting satellite, according to a customer preference to receive power from a particular providing entity among a set of possible power providing entities, or both. After identifying a suitable providing satellite, the system verifies alignment between the power transmission element and the power receiving elements of the respective satellites and issues element alignment commands if needed to alter the disposition of at least one of the power transmission and power receiving elements to achieve the necessary element alignment before transmission occurs.

During transmission, the system tracks the cumulative amount of power transmitted from the provider and receives validation from the customer satellite is receiving the requested power. The system also tracks alignment and relative satellite positioning to ensure that the providing satellite remains the best provider option over the course of the requested transmission. As necessary to maintain alignment, the system issues additional alignment adjustment commands to at least one of the providing satellite and the customer satellite to alter transmission or receiving elements to maintain transmission/receiving element alignment as the satellites traverse their respective orbits.

In an embodiment, over the span of the requested power transmission, the best option for providing power may change due to relative motion between satellites. In an embodiment, the system checks customer preferences to ensure that the potential new provider is acceptable, ensures that alignment is possible between the potential new provider and the customer, issues alignment commands to the potential new provider or the customer if needed, and switches the provision of power from the initial provider to the new provider.

In an embodiment, the system avoids power transmission outages between provider and customers as switching between provider satellites occurs by ensuring alignment between the new provider and customer concurrent with proper alignment between the initial provider and customer and switching on transmission from the new provider prior to switching off transmission rom the initial provider. The concurrent transmission prevents power reception outages.

In an embodiment, the system updates the ledger entry with the cumulative power provided by the initial provider satellite together with the billing rate for that power, as well as the details for the new provider, and begins tracking the cumulative power from the new provider satellite. In an embodiment, the initial and new provider satellites may be associated with a common power providing entity, or they may be associated with differing power providing entities. In this embodiment, the system updates the power request ledger entry indicating each power providing satellite along with the metadata for each providing satellite including billing entity, billing rate, cumulative power transmitted etc. Similar to the initial power request version of the ledger entry, the system submits a digitally signed version of each updated version of the ledger entry to the peer group for validation as described above before the updated ledger entry becomes an actual part of the ledger.

In an embodiment, the use of the blockchain to memorialize the power request/receipt transactions provides a trusted means for multiple customers to request/receive power from multiple power providers without revealing individual power consumption details or habits which may reveal sensitive business information.

In accordance with aspects of the invention there is a method for automatically receiving and fulfilling power requests among networks of power generation/distribution satellites and power receiving customer satellites. In an embodiment, the method receives a power distribution request from a customer satellite, identifies a power providing satellite capable of fulfilling the request, and ensures proper transmission/reception alignment between the customer and provider satellites. In an embodiment, the method selects a power supply satellite nearest to the requesting satellite according to the respective orbital locations and orbital dynamics of the satellites. Initiating the transmission of power between the satellites and memorializing the transmission of power and appropriate billing details within a common ledger.

Aspects of the invention also provide an improvement to computer functionality. In particular, implementations of the invention are directed to a specific improvement to the way computer controlled power distribution systems operate, embodied in the continually adjusted alignment between transmission/receiving elements as well as provider satellite selection over the course of providing requested power to a customer satellite. In embodiments, the system issues transmission/reception element adjustment commands to maintain alignment between the elements during the transmission of power.

In an embodiment, one or more components of the system can employ hardware and/or software to solve problems that are highly technical in nature (e.g., continuously determining the relative locations and transmission/reception element alignment of orbiting satellites, tracking the cumulative transmission of power, memorializing power requests and the fulfillment of those requests, etc.). These solutions are not abstract and cannot be performed as a set of mental acts by a human due to the processing capabilities needed to facilitate automatic power distribution among networks of satellites. Further, some of the processes performed may be performed by a specialized computer for carrying out defined tasks related to satellite power distribution. For example, a specialized computer can be employed to carry out tasks related to orbital power distribution, or the like.

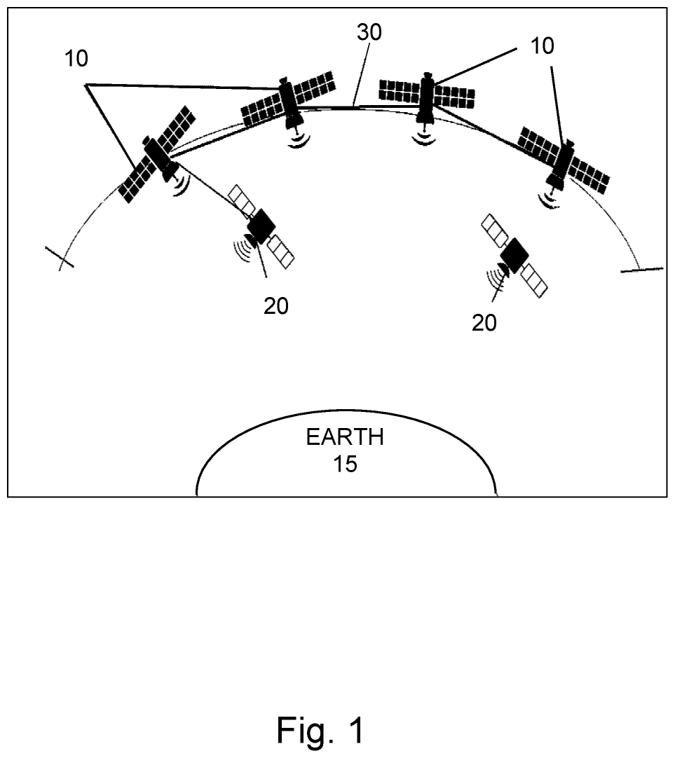

As shown in FIG. 1, an array of power generation/distribution satellites 10 reside in orbit above the Earth 15. The satellites 10 may reside in a common orbit or may reside in individual orbits. The orbits may be geosynchronous or may be at a non-geosynchronous altitude.

The power generation/distribution satellites 10 comprise power generation elements such as photo-voltaic conversion panels, or other power generation elements. The satellites 10 further comprise power storage components (not shown) such as battery components, enabling the storage of generated power during time periods where less power is being requested/transmitted that the quantity currently being generated. The satellites 10 further comprise power transmission elements and power receiving elements, as well as communications transmission and receiving elements. The power transmission and receiving elements, as well as the communications transmission and receiving elements may comprise actuators enabling alignment positioning of these elements subject to alignment commands. The satellites 10 comprise altitude and orientation adjustment elements enabling repositioning the satellite to a different altitude, a different orientation or a different orbit. The satellites comprise one or more controlling processors to adjust satellite altitude and orientation in response to received commands of in response to inputs from sensors such as position sensing radars, global positioning system (GPS) sensors, etc. Such controllers also enable the satellites to participate as nodes or peers in the processing of submitted blockchain ledger entries.

In an embodiment, satellites 10 comprise a network wherein power may be shared 30 among the network of satellites for eventual distribution to requesting customers. In this embodiment, power from a first satellite may be transmitted to a second satellite for distribution or for storage in an event where the first satellite has reached it maximum storage capacity and the second satellite has not.

As shown in the figure, customer satellite 20 also reside in orbit above the Earth. Customer satellite 20 orbits may be coincident with those of power generation/distribution satellites 10, or the orbits may differ from those of satellites 10. Similar to power generation/distribution satellites 10, customer satellites 20 may also comprise power generation and storage elements as well as communication and power transmission and receiving elements, each of such elements adjustable in terms of alignment in response to alignment altering commands. The customer satellites 20 comprise altitude and orientation adjustment elements enabling repositioning the satellite to a different altitude, a different orientation or a different orbit. The customer satellites 20 comprise one or more controlling processors to adjust satellite altitude and orientation in response to received commands of in response to inputs from sensors such as position sensing radars, global positioning system sensors, etc. Such controllers also enable the customer satellites 20 to participate as nodes or peers in the processing of submitted blockchain ledger entries.

In an embodiment, the requestor comprises a ground station (not shown) rather than an orbiting satellite. In this embodiment, the ground station requires power from the satellite distribution array and requests power by submitting a power request ledger entry to the blockchain nodes for validation, similar to customer satellite 20. Also similar to satellite 20, the ground station comprises power receiving elements and communications transmission and receiving elements. Upon receipt of the validated ledger entry requesting power, the systems and methods identify one or more power supply satellites appropriately located to transmit power to the ground station receiving element. After ensuring proper alignment by altering the alignment of transmitting and receiving elements, the systems and methods enable transmission from the identified power supply satellites to the ground station, otherwise following the steps outlined above for submitting ledger entries memorializing the transaction, and maintaining proper alignment of transmission and receiving elements, as well as changing power supplying satellites if necessary to complete the requested power transmission.

In an embodiment, power supply satellites 10 comprise multiple power transmission elements, each transmission element capable of adjustment to a different target receiving element through alignment commands and the associated alignment adjustment apparatus. Similarly, each customer satellite may comprise multiple receiving elements capable of alignment adjustments enabling the receipt of power from multiple transmission elements distributed across the power generation/distribution network.

In an embodiment, the power transmission and receiving elements of satellites 10 and 20 comprises elements which convert electrical power to laser light and transmit the laser beams from the providing satellites to the customer satellite 20 where the receiving element converts the received laser light to electrical power.

In an embodiment, a satellite 20 comprises an ISM module. In this embodiment, the momentary or otherwise projected power needs of the ISM exceed the momentary or projected power available from the power generation elements of the satellite 20, together with the stored power of the satellite 20. In this embodiment, satellite 20 submits a transaction to the distribution computer system as a submitted blockchain ledger entry providing satellite 20 location and power need details. After validation of the submitted ledger entry by participating nodes of the power sharing network, the system identifies a power supplying satellite to fulfill the request. Disclosed systems and methods check transmission/reception element alignment between the requesting the power supply satellites and transmits alignment adjustment commands as needed before enabling the transmission of power to the requesting satellite. During the transmission of power, systems and methods track the cumulative power transmitted and apply an appropriate billing rate defined by a relationship between the entity controlling the requesting satellite and the entity controlling the power supplying satellite. The systems/methods submit updated ledger entries memorializing the fulfillment stages of the power request, including power transmitted by the one or more power supplying satellites to the requestor, and in some embodiments payment transfers completed in response to billing invoices submitted for power supplied. After consensus approval by participating network nodes, methods save the fulfilled ledger entries to the blockchain. Each participant maintains a copy of the ledger.

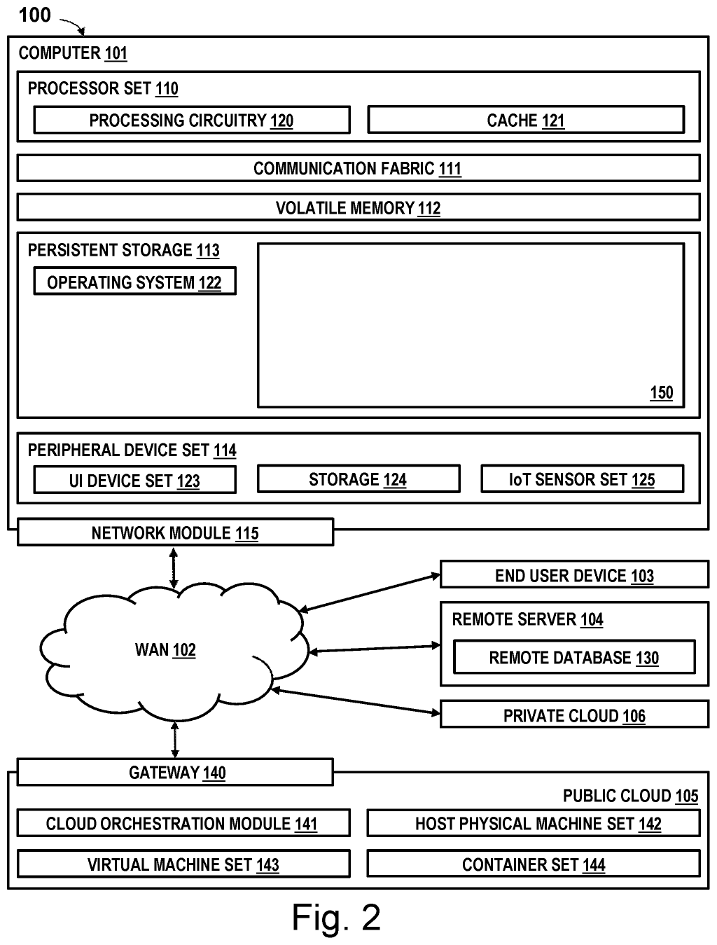

As shown in FIG. 2, computing environment 100 contains an example of an environment for the execution of at least some of the computer code involved in performing the inventive methods, such as satellite power distribution. Such code may be stored for execution in code block 150 of the figure. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 2. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive satellite power distribution methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

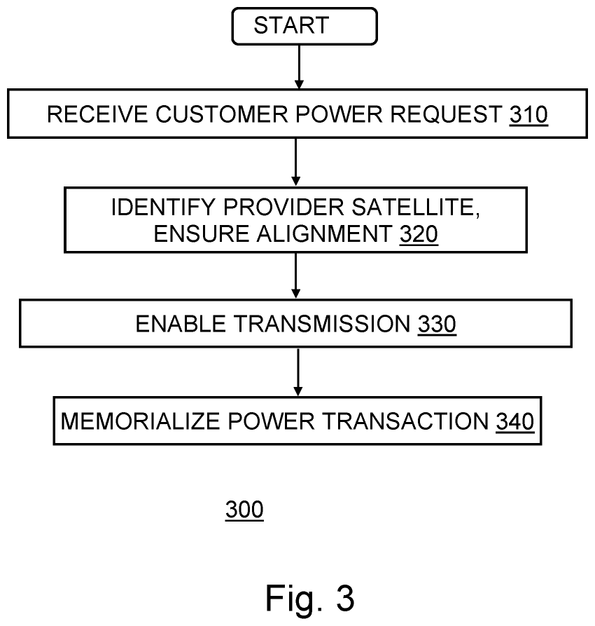

FIG. 3 provides a flowchart 300, illustrating exemplary activities associated with the practice of the disclosure. After program start, at block 310, a power distribution system receives a power distribution request from a customer for a particular customer satellite. The request provides the power required as well as satellite details regarding current location and orbital dynamics. In an embodiment, the system receives the request in the form of a validated blockchain ledger entry including the necessary information for the request.

At block 320, the system identifies a power supply satellite to fulfill the request using the known location and orbital dynamics information of the requestor as well of the array of possible power supply satellites. In an embodiment, the system identifies a power supply satellite according to the relative locations of power supply and the requesting customer satellites. In this embodiment, the system selects the power supply satellite nearest to the requesting customer satellite. After identifying a power supplying satellite which has acceptable location, orbital dynamics and metadata satisfying any particular customer preferences for power providers, the system checks for proper alignment between the identified power supplying satellite and the requesting customer satellite. In an embodiment, the system issues alignment altering commands to at least one the power supplying satellite and the customer satellite to alter the orientation of the respective power transmitting and power receiving elements of those satellites to bring those elements into alignment for the power transmission.

At block 330, systems and methods enable transmission of power by way of laser, or other means, between the power supplying satellite and the power requesting satellite. During the transmission, the system maintains alignment between power transmission and power receiving elements by tracking the locations of the satellites using radar, GPS or other sensors as well as monitoring the efficiency of the power transmission itself. Systems and methods generate and transmit alignment altering commands to at least one of the power supplying and power receiving satellites as needed to maintain efficient transmission/reception. In this embodiment, systems and methods change the power supplying satellite during the transmission as the respective orbital dynamics of the participating satellites alter the power supplying satellite which can most efficiently provide the requested power to the customer satellite.

At block 340, systems and methods memorialize changes in the power supplying satellite together with the cumulative power supplied by each power supplying satellite to the customer satellite in revised ledger entries submitted to participating peers of the blockchain network for validation and entry into the ledger. Such submitted ledger entries include appropriate power billing rates for each power supplier/customer combination. In an embodiment, systems and methods submit periodic billing statements to customers utilizing the network with such billing statements including power supplied and associated costs for the power. In an embodiment, the distributed ledger includes customer account details enabling automatic billing of provided power at the completion of the provision of power, or continuously as power is provided. In an embodiment, systems and methods track billing and payment using distributed ledger entries which are reviewed and confirmed by nodes of the ledger prior to entry as part of a block of the ledger.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

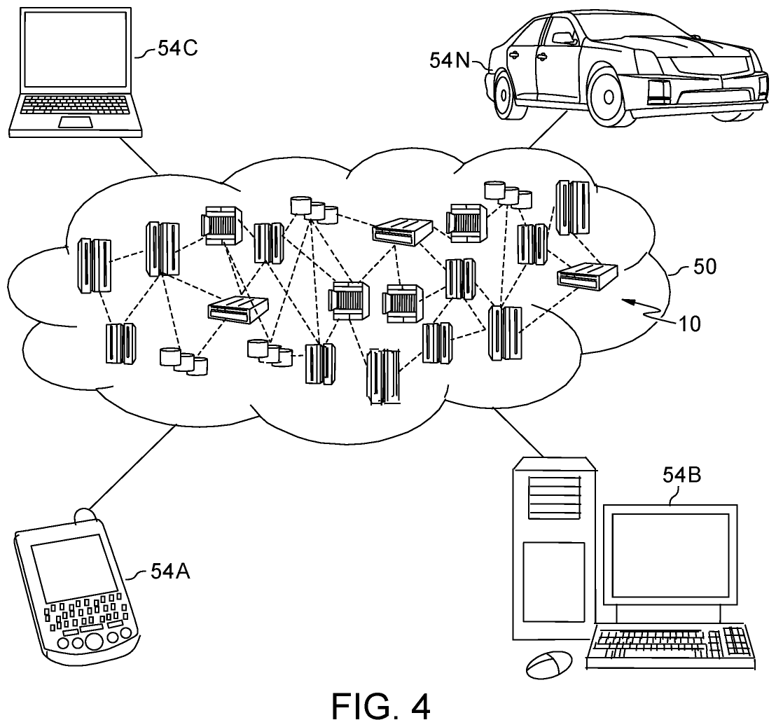

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

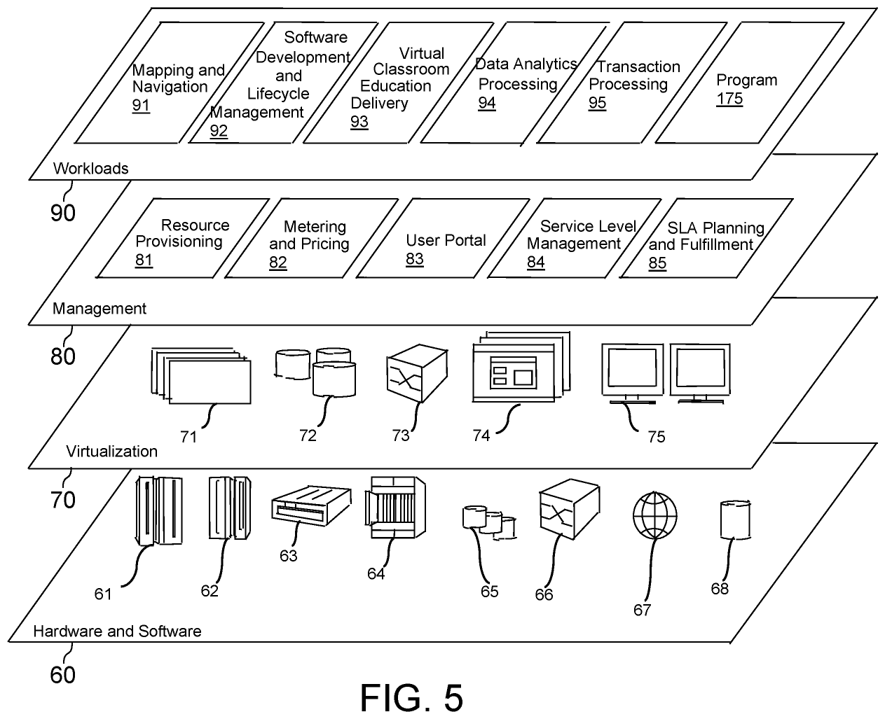

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and power distribution program 175.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for providing power to orbiting satellites, the method comprising:
providing an array including at least one power generating supply satellites;
receiving, by one or more computer processors, a power request from a customer satellite;
ensuring, by the one or more computer processors, angular alignment between a power transmitting element of a supply satellite and a power receiving element of the customer satellite;
enabling, by the one or more computer processors, power transmission from the supply satellite to the customer satellite; and
recording, by the one or more computer processors, a quantity of power transmitted from the supply satellite to the customer satellite.

2. The computer implemented method according to claim 1, further comprising storing generated power at the supply satellite.

3. The computer implemented method according to claim 1, further comprising transmitting power between two supply satellites.

4. The computer implemented method according to claim 1, further comprising:
determining, by the one or more computer processors, an orbital location of a requesting customer satellite;
determining, by the one or more computer processors, a supply satellite nearest to the customer satellite according to the orbital location; and
providing power to the customer satellite from the supply satellite.

5. The computer implemented method according to claim 1, wherein receiving the power request and recording the quantity of power transmitted from the supply satellite to the customer satellite comprises recording the power request and the quantity of power using a distributed ledger.

6. The computer implemented method according to claim 1, further comprising recording, by the one or more computer processors, a power transfer transaction quantity according to the supply satellite, the customer satellite, and the quantity of power transmitted.

7. The computer implemented method according to claim 1, further comprising adjusting, by the one or more computer processors, an angular position of at least one of the supply satellite power transmission element and the customer satellite power receiving element during the transmission of the power.

8. A computer program product for providing power to orbiting satellites, the computer program product comprising one or more computer readable storage media and collectively stored program instructions on the one or more computer readable storage media the program instructions executable by a processor to cause the processor to perform a method comprising:
receiving a power request from a customer satellite;
ensuring angular alignment between a power transmitting element of a supply satellite and a power receiving element of the customer satellite;
transmitting power from the supply satellite to the customer satellite; and
recording a quantity of power transmitted from the supply satellite to the customer satellite.

9. The computer program product according to claim 8, the method further comprising storing generated power at the supply satellite.

10. The computer program product according to claim 8, the method further comprising transmitting power between two supply satellites.

11. The computer program product according to claim 8, the method further comprising:
determining an orbital location of a requesting customer satellite;
determining a supply satellite nearest to the customer satellite according to the orbital location; and
providing power to the customer satellite from the supply satellite.

12. The computer program product according to claim 8, wherein receiving the power request and recording the quantity of power transmitted from the supply satellite to the customer satellite comprises recording the power request and the quantity of power using a distributed ledger.

13. The computer program product according to claim 8, the method further comprising recording a power transfer transaction quantity according to the supply satellite, the customer satellite, and the quantity of power transmitted.

14. The computer program product according to claim 8, the method further comprising adjusting an angular position of at least one of the supply satellite power transmission element and the customer satellite power receiving element during the transmission of the power.

15. A computer system for distributing power across a network, the system comprising:
an array comprising at least one power supply satellite;
one or more computer processors;
one or more computer readable storage devices; and
stored program instructions on the one or more computer readable storage devices which, when executed by at least one processor, cause the processor to perform a method comprising:
receiving a power request from a customer satellite;
ensuring angular alignment between a power transmitting element of a supply satellite and a power receiving element of the customer satellite;
transmitting power from the supply satellite to the customer satellite; and
recording a quantity of power transmitted from the supply satellite to the customer satellite.

16. The computer system according to claim 15, the method further comprising storing generated power at the supply satellite.

17. The computer system according to claim 15, the method further comprising transmitting power between two supply satellites.

18. The computer system according to claim 15, the method further comprising:
determining an orbital location of a requesting customer satellite;
determining a supply satellite nearest to the customer satellite according to the orbital location; and
providing power to the customer satellite from the supply satellite.

19. The computer system according to claim 15, wherein receiving the power request and recording the quantity of power transmitted from the supply satellite to the customer satellite comprises recording the power request and the quantity of power using a distributed ledger.

20. The computer system according to claim 15, the method further comprising recording a power transfer transaction quantity according to the supply satellite, the customer satellite, and the quantity of power transmitted.
